(19) United States
(12) Patent Application Publication
(10) Pub. No.: US 2021/0095978 A1
(43) Pub. Date: Apr. 1, 2021

(54) Autonomous Navigation for Light Electric Vehicle Repositioning

(71) Applicant: Uber Technologies, Inc., San Francisco, CA (US)

(72) Inventors: Nicholas G. Letwin, Pittsburgh, PA (US); Eric Meyhofer, Pittsburgh, PA (US); Sean Hyde, Pittsburgh, PA (US); Michael Beckmann, San Francisco, CA (US); Jahan Khanna, San Francisco, CA (US); Sylvia Wu, San Francisco, CA (US); Zoran Martinovic, San Francisco, CA (US); Nicholas Foley, San Francisco, CA (US); Lucie Zikova, San Francisco, CA (US)

(21) Appl. No.: 16/584,000

(22) Filed: Sep. 26, 2019

(51) Int. Cl. G01C 21/34; G05D 1/00; B60L 15/20; G01C 21/12; G05D 1/02

(52) U.S. Cl. CPC G01C 21/3438; G05D 1/0088; B60L 15/20; B60L 2200/12; G05D 1/0231; G05D 1/0038; G01C 21/12

(57) ABSTRACT

Systems and methods for repositioning light electric vehicles are provided. A method can include obtaining, by a computing system, sensor data from one or more sensors located onboard an autonomous light electric vehicle, determining, by the computing system, one or more navigational instructions to reposition the autonomous light electric vehicle based at least in part on the sensor data, and causing, by the computing system, the autonomous light electric vehicle to initiate travel based at least in part on the one or more navigational instructions. The one or more navigational instructions can be one or more navigational instructions associated with repositioning the autonomous light electric vehicle at a light electric vehicle designated parking location, a light electric vehicle charging station, a light electric vehicle collection point, a light electric vehicle rider location, or a light electric vehicle supply positioning location.

### FIELD

The present disclosure relates generally to devices, systems, and methods for autonomous navigation using sensor data from an autonomous light electric vehicle.

### BACKGROUND

Light electric vehicles (LEVs) can include passenger carrying vehicles that are powered by a battery, fuel cell, and/or hybrid-powered. LEVs can include, for example, bikes and scooters. Entities can make LEVs available for use by individuals. For instance, an entity can allow an individual to rent/lease an LEV upon request on an on-demand type basis. The individual can pick-up the LEV at one location, utilize it for transportation, and leave the LEV at another location, where the LEV can be made available for use by other individuals.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for repositioning an autonomous light electric vehicle. The computer-implemented method can include obtaining, by a computing system comprising one or more computing devices, sensor data from one or more sensors located onboard an autonomous light electric vehicle. The computer-implemented method can further include determining, by the computing system, one or more navigational instructions to reposition the autonomous light electric vehicle based at least in part on the sensor data. The computer-implemented method can further include causing, by the computing system, the autonomous light electric vehicle to initiate travel based at least in part on the one or more navigational instructions. The one or more navigational instructions can be one or more navigational instructions associated with repositioning the autonomous light electric vehicle at a light electric vehicle designated parking location, a light electric vehicle charging station, a light electric vehicle collection point, a light electric vehicle rider location, or a light electric vehicle supply positioning location.

Another example aspect of the present disclosure is directed to a computing system. The computing system can include one or more processors and one or more tangible, non-transitory, computer readable media that store instructions that when executed by the one or more processors cause the computing system to perform operations. The operations can include obtaining image data from one or more cameras located onboard an autonomous light electric vehicle. The operations can further include determining a particular location to reposition the autonomous light electric vehicle based at least in part on the image data. The operations can further include determining one or more navigational instructions for the autonomous light electric vehicle to travel to the particular location. The operations can further include communicating the one or more navigational instructions to the autonomous light electric vehicle.

Another example aspect of the present disclosure is directed to an autonomous light electric vehicle. The autonomous light electric vehicle can include one or more sensors, one or more processors, and one or more tangible, non-transitory, computer readable media that store instructions that when executed by the one or more processors cause the one or more processors to perform operations. The operations can include obtaining sensor data from the one or more sensors. The operations can further include determining one or more navigational instructions to travel to a particular location based at least in part on the sensor data. The operations can further include causing the autonomous light electric vehicle to initiate travel based at least in part on the one or more navigational instructions. The particular location can be a designated light electric vehicle parking location, a light electric vehicle charging station, a light electric vehicle collection point, a light electric vehicle rider location, or a light electric vehicle supply positioning location.

Other aspects of the present disclosure are directed to various computing systems, vehicles, apparatuses, tangible, non-transitory, computer-readable media, and computing devices.

The technology described herein can help improve the safety of passengers of an autonomous LEV, improve the safety of the surroundings of the autonomous LEV, improve the experience of the rider and/or operator of the autonomous LEV, as well as provide other improvements as described herein. Moreover, the autonomous LEV technology of the present disclosure can help improve the ability of an autonomous LEV to effectively provide vehicle services to others and support the various members of the community in which the autonomous LEV is operating, including persons with reduced mobility and/or persons that are underserved by other transportation options. Additionally, the autonomous LEV of the present disclosure may reduce traffic congestion in communities as well as provide alternate forms of transportation that may provide environmental benefits.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example autonomous light electric vehicle computing system according to example aspects of the present disclosure;

FIG. 2 depicts an example autonomous light electric vehicle and orientation adjustment device according to example aspects of the present disclosure;

FIG. 3A depicts an example image of a walkway and street according to example aspects of the present disclosure;

FIG. 3B depicts an example image segmentation of the example image of the walkway and street according to example aspects of the present disclosure;

FIG. 4 depicts an example location selection by a teleoperator according to example aspects of the present disclosure;

FIG. 5 depicts an example navigation of an autonomous light electric vehicle along a fiducial path according to example aspects of the present disclosure;

FIG. 6 depicts an example method according to example aspects of the present disclosure;

FIG. 7 depicts an example method according to example aspects of the present disclosure; and

FIG. 8 depicts example system components according to example aspects of the present disclosure.

### DETAILED DESCRIPTION

Example aspects of the present disclosure are directed to systems and methods for navigating autonomous light electric vehicles (LEVs) using data from sensors located onboard the autonomous LEVs. For example, an autonomous LEV can be an electric-powered bicycle, scooter, or other light vehicle, and can be configured to operate in a variety of operating modes, such as a manual mode in which a human operator controls operation, a semi-autonomous mode in which a human operator provides some operational input, or a fully autonomous mode in which the autonomous LEV can drive, navigate, operate, etc. without human operator input.

LEVs have increased in popularity in part due to their ability to help reduce congestion, decrease emissions, and provide convenient, quick, and affordable transportation options, particularly within densely populated urban areas. For example, in some implementations, a rider can rent a LEV to travel a relatively short distance, such as several blocks in a downtown area. However, due to potential logistical constraints and/or regulatory restrictions, LEVs may occasionally need to be repositioned when not in use. For example, a municipality may place restrictions on where LEVs can be parked, such as by requiring LEVs to be parked in designated parking locations. However, upon a rider reaching his or her destination, the rider may leave the LEV in an unauthorized parking location, and therefore the LEV may need to be repositioned into a designated parking location. Similarly, LEVs may occasionally need to be collected by a fleet manager, such as to redistribute the LEVs to better meet rider demand or for battery charging, but infrastructure constraints may require charging equipment or transportation equipment to only be accessible in particular locations. Thus, the LEVs may need to be repositioned to allow for more convenient collection, supply positioning, charging, etc.

The systems and methods of the present disclosure can allow for LEVs to be repositioned by, for example, enabling autonomous or semi-autonomous travel to a desired location. For example, to assist with autonomous operation, an autonomous LEV can include various sensors. Such sensors can include inertial measurement sensors (e.g., accelerometers), cameras (e.g., fisheye cameras, infrared cameras, etc.), radio beacon sensors (e.g., Bluetooth low energy sensors), GPS sensors (e.g., GPS receivers/transmitters), ultrasonic sensors, radio sensors (e.g., cellular, WiFi, V2X, etc.) and/or other sensors configured to obtain data indicative of an environment in which the autonomous LEV is operating.

According to example aspects of the present disclosure, a computing system can obtain sensor data from one or more sensors located onboard the autonomous LEV. For example, in some implementations, the computing system can be located onboard the autonomous LEV. In some implementations, the computing system can be a remote computing system, and can be configured to receive sensor data uploaded from one or more autonomous LEVs, such as over a communications network. For example, an autonomous LEV can upload sensor data (e.g., image data) to a remote computing device via a communication device (e.g., a cellular transmitter) over a communications network.

Further, the computing system can determine one or more navigational instructions for repositioning the autonomous vehicle based at least in part on the sensor data. For example, in some implementations, image data can be analyzed to determine where and how to navigate to a particular location. As an example, one or more image segmentation models can be used to segment or partition image data into a plurality of segments, such as, for example, a foreground, a background, a walkway, sections of a walkway, roadways, charging stations, designated parking locations, collection points, customer locations, various objects (e.g., vehicles, people, trees, benches, tables, etc.), and/or other segments.

In some implementations, the computing system can determine a particular location for the autonomous LEV to travel to based at least in part on the sensor data. For example, a remote computing system can analyze an image uploaded by an autonomous LEV and determine that the autonomous LEV is parked on an unauthorized section of a walkway (e.g., a passenger throughway of a sidewalk), and therefore the autonomous LEV needs to move to a designated parking location. Further, the remote computing system can identify whether any designated parking locations are included in the image. For example, the remote computing system can analyze the image to determine a ground plane, locate a designated parking location within the ground plane, and then determine one or more navigational instructions for the autonomous LEV to travel to the designated parking location.

In some implementations, a remote teleoperator can determine a particular location to which the autonomous LEV is to travel. As an example, an image can be uploaded from an autonomous LEV, and displayed for the remote teleoperator to view. The teleoperator can input a particular location, such as by selecting a designated parking location in the image (e.g., by clicking on an area of the image corresponding to the designated parking location), and the remote computing system can determine the one or more navigational instructions to travel to the designated parking location. The remote computing system can then communicate the one or more navigational instructions to the autonomous LEV.

Similarly, in some implementations, an autonomous LEV may determine that a battery of the autonomous LEV needs to be charged, such as when a battery charge level drops below a threshold, and the autonomous LEV can determine that the autonomous LEV should travel to a charging station or a collection point to be charged. Additionally, in some implementations, a remote computing system can send one or more navigational instructions to an autonomous LEV to travel to a customer location (e.g., such as when a customer requests an autonomous LEV) or to be in an area of anticipated demand (e.g., for supply positioning).

In some implementations, the computing system can determine an authorized section of a travelway in which the autonomous light electric vehicle is permitted to travel. For example, the computing system can analyze an image to identify a bicycle lane or an authorized section of a walkway (e.g., a sidewalk section) in which the autonomous light electric vehicle is permitted to travel, and further, determine the one or more navigational instructions to travel within the authorized section.

In some implementations, the one or more navigational instructions can include one or more dead-reckoning instructions, vector-based instructions, and/or waypoints. As an example, the one or more instructions can include a direction to travel (e.g., a heading) and a distance to travel relative to the current position of the autonomous LEV. In some implementations, the one or more navigational instructions can include a plurality of waypoints (e.g. intermediate points along a path of travel) to navigate to a particular location.

In some implementations, the one or more navigational instructions can include instructions to travel to and follow a fiducial path. The fiducial path can be, for example, a predetermined, recognizable path for the autonomous LEV to travel on which can be followed without computationally-intensive analysis. For example, a fiducial path can include various painted lines, buried wires, magnetic strips, beacons, etc. to mark the fiducial path, and the autonomous LEV can be configured to recognize and follow the fiducial path. The one or more navigational instructions can include instructions to travel to the fiducial path, and further, to travel along at least a portion of the fiducial path. In some implementations, the one or more navigational instructions can include instructions to navigate from the fiducial path to a particular location (e.g., such as after the autonomous LEV travels along the path for a predetermined distance).

In some implementations, a remote computing system can communicate one or more commands to an autonomous LEV to attempt to detect (e.g., identify) a fiducial path in a surrounding environment of the autonomous LEV. As an example, an autonomous LEV may be located in an area near a fiducial path, and the remote computing system can communicate data indicative of the fiducial path (e.g., a unique identifier associated with a fiducial, a type of fiducial, etc.) to the autonomous LEV. The autonomous LEV can then use sensor data (e.g., image data, radio beacon data, etc.) to detect the fiducial path. Further, the autonomous LEV can navigate to and along the fiducial path to autonomously reposition the autonomous LEV.

The computing system can then cause the autonomous LEV to travel based at least in part on the one or more navigational instructions. For example, a vehicle control system of the autonomous LEV can cause the autonomous LEV to travel in the heading (e.g., direction) for the distance indicated in the one or more navigational instructions.

In some situations, an autonomous LEV may be unable to travel due to being tipped over (e.g., in a lying down orientation). According to additional aspects of the present disclosure, the computing system can determine that an autonomous LEV is in a lying down orientation based at least in part on the sensor data. For example, inertial measurement data (e.g. accelerometer data) and/or image data can indicate that the autonomous LEV is in the lying down orientation. In some implementations, the autonomous LEV can use an orientation adjustment device, such as a rotating kickstand or gyroscope, to cause the autonomous LEV to stand up from the lying down orientation to an upright orientation. Once in the upright orientation, the autonomous LEV can travel according to the one or more navigational instructions.

In some implementations, the computing system can obtain subsequent sensor data to determine whether the autonomous LEV has travelled to a desired destination (e.g., a particular location). For example, after completing travel according to the one or more navigational instructions, subsequent sensor data, such as a subsequent image, can be obtained, and if needed, one or more subsequent navigational instructions can be determined to travel to the desired destination based at least in part on the subsequent sensor data. The autonomous vehicle can then travel in accordance with the subsequent navigational instructions.

The systems and methods of the present disclosure can provide any number of technical effects and benefits. More particularly, the systems and methods of the present disclosure provide improved techniques for autonomous navigation for an autonomous LEV. For example, as described herein, a computing system can determine one or more navigational instructions for an autonomous LEV using sensor data obtained from one or more sensors onboard the autonomous LEV. For example, image data from a camera can be used to determine whether the autonomous LEV is located in an appropriate location and/or where and how to navigate to a particular location. For example, images obtained from a camera can be analyzed using one or more machine-learned models, such as image segmentation models, ground plane models, or walkway detection models, orientation analysis models, or other models determine how to navigate the autonomous LEV. In some implementations, the analysis can be performed onboard the autonomous LEV, while in other implementations, the analysis can be performed by a remote computing device. Using a remote computing device to determine the one or more navigational instructions for the autonomous LEV can help to conserve the computational and battery resources of the autonomous LEV. Further, the autonomous LEV can be controlled to travel according to the navigational instructions, thereby allowing for repositioning of the autonomous LEV.

In turn, the systems and methods described herein can improve compliance with applicable restrictions and/or regulations. For example, by enabling autonomous navigation, the location of the autonomous LEV can be proactively managed in order to help ensure compliance with applicable regulatory requirements. For example, parking compliance can be actively managed for autonomous LEVs, such as by detecting when an autonomous LEV has been parked in an unauthorized section of a walkway and navigating the autonomous LEV to a designated parking location. For example, the autonomous LEV can be moved from a pedestrian throughway of a walkway (e.g., sidewalk) to a furniture zone of the walkway.

Moreover, the systems and methods described herein can increase the safety of LEV operation for riders and pedestrians. For example, by repositioning improperly parked autonomous LEVs, such as by autonomously moving an autonomous LEV from a pedestrian throughway to an authorized parking location, walkway congestion can be improved for pedestrians.

Example aspects of the present disclosure can provide an improvement to vehicle computing technology, such as autonomous LEV computing technology. For example, the systems and methods of the present disclosure provide an improved approach to autonomous navigation for an autonomous LEV. For example, a computing system (e.g., a computing system on board an autonomous LEV or a remote computing system) can obtain sensor data from a sensor located onboard an autonomous LEV. The sensor can be, for example, an accelerometer, a camera, a radio beacon sensor, and/or a GPS sensor. The computing system can further determine one or more navigational instructions based at least in part on the sensor data. For example, the computing system (and/or a teleoperator) can analyze image data to determine that an autonomous LEV is located in an unauthorized parking location, and determine the location of a designated parking location, such as by semantically segmenting the image. Further, the computing system can determine one or more navigational instructions to navigate to the designated parking location. For example, a ground plane analysis of an image can determine a drivable surface, and the computing system can determine one or more navigational instructions to travel to the designated parking location on the drivable surface. The one or more navigational instructions can be, for example, dead-reckoning, vector-based, or waypoint-based navigational instructions. The autonomous LEV can then be controlled to initiate travel based at least in part on the one or more navigational instructions. For example, a vehicle control system of the autonomous LEV can cause the autonomous LEV to travel in the heading indicated by the navigational instructions for a specified distance.

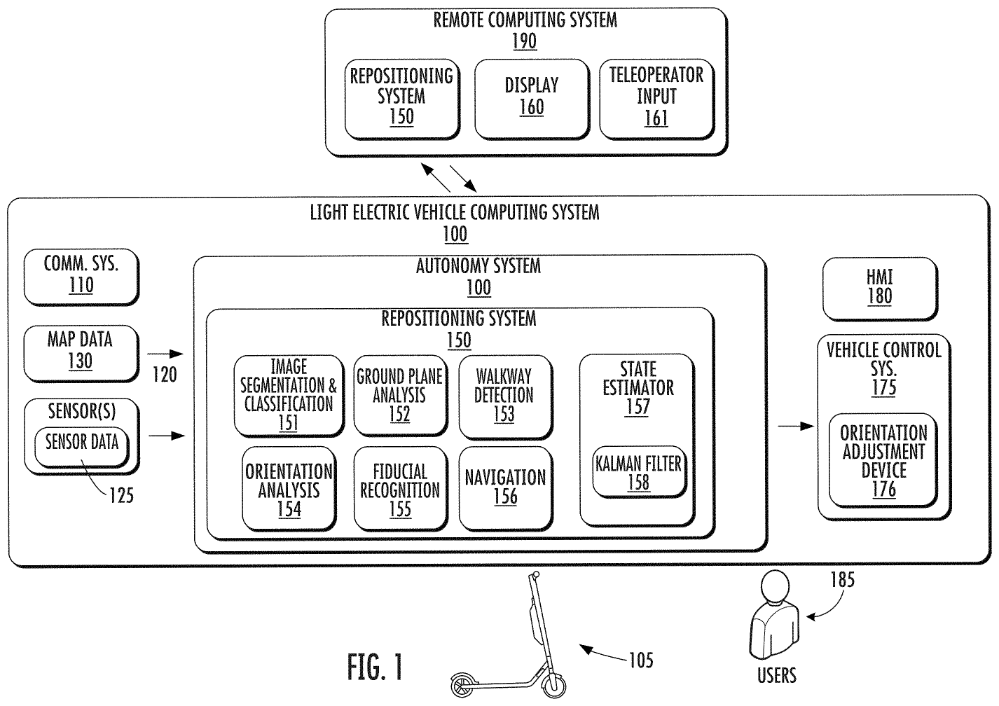

With reference now to the FIGS., example aspects of the present disclosure will be discussed in further detail. FIG. 1 illustrates an example LEV computing system 100 according to example aspects of the present disclosure. The LEV computing system 100 can be associated with an autonomous LEV 105. The LEV computing system 100 can be located onboard (e.g., included on and/or within) the autonomous LEV 105.

The autonomous LEV 105 incorporating the LEV computing system 100 can be various types of vehicles. For instance, the autonomous LEV 105 can be a ground-based autonomous LEV such as an electric bicycle, an electric scooter, an electric personal mobility vehicle, etc. The autonomous LEV 105 can travel, navigate, operate, etc. with minimal and/or no interaction from a human operator (e.g., rider/driver). In some implementations, a human operator can be omitted from the autonomous LEV 105 (and/or also omitted from remote control of the autonomous LEV 105). In some implementations, a human operator can be included in and/or associated with the autonomous LEV 105, such as a rider and/or a remote teleoperator.

In some implementations, the autonomous LEV 105 can be configured to operate in a plurality of operating modes. The autonomous LEV 105 can be configured to operate in a fully autonomous (e.g., self-driving) operating mode in which the autonomous LEV 105 is controllable without user input (e.g., can travel and navigate with no input from a human operator present in the autonomous LEV 105 and/or remote from the autonomous LEV 105). The autonomous LEV 105 can operate in a semi-autonomous operating mode in which the autonomous LEV 105 can operate with some input from a human operator present in the autonomous LEV 105 (and/or a human teleoperator that is remote from the autonomous LEV 105). The autonomous LEV 105 can enter into a manual operating mode in which the autonomous LEV 105 is fully controllable by a human operator (e.g., human rider, driver, etc.) and can be prohibited and/or disabled (e.g., temporary, permanently, etc.) from performing autonomous navigation (e.g., autonomous driving). In some implementations, the autonomous LEV 105 can implement vehicle operating assistance technology (e.g., collision mitigation system, power assist steering, etc.) while in the manual operating mode to help assist the human operator of the autonomous LEV 105.

The operating modes of the autonomous LEV 105 can be stored in a memory onboard the autonomous LEV 105. For example, the operating modes can be defined by an operating mode data structure (e.g., rule, list, table, etc.) that indicates one or more operating parameters for the autonomous LEV 105, while in the particular operating mode. For example, an operating mode data structure can indicate that the autonomous LEV 105 is to autonomously plan its motion when in the fully autonomous operating mode. The LEV computing system 100 can access the memory when implementing an operating mode.

The operating mode of the autonomous LEV 105 can be adjusted in a variety of manners. For example, the operating mode of the autonomous LEV 105 can be selected remotely, off-board the autonomous LEV 105. For example, a remote computing system 190 (e.g., of a vehicle provider and/or service entity associated with the autonomous LEV 105) can communicate data to the autonomous LEV 105 instructing the autonomous LEV 105 to enter into, exit from, maintain, etc. an operating mode. By way of example, such data can instruct the autonomous LEV 105 to enter into the fully autonomous operating mode. In some implementations, the operating mode of the autonomous LEV 105 can be set onboard and/or near the autonomous LEV 105. For example, the LEV computing system 100 can automatically determine when and where the autonomous LEV 105 is to enter, change, maintain, etc. a particular operating mode (e.g., without user input). Additionally, or alternatively, the operating mode of the autonomous LEV 105 can be manually selected via one or more interfaces located onboard the autonomous LEV 105 (e.g., key switch, button, etc.) and/or associated with a computing device proximate to the autonomous LEV 105 (e.g., a tablet operated by authorized personnel located near the autonomous LEV 105). In some implementations, the operating mode of the autonomous LEV 105 can be adjusted by manipulating a series of interfaces in a particular order to cause the autonomous LEV 105 to enter into a particular operating mode. In some implementations, the operating mode of the autonomous LEV 105 can be selected via a user's computing device (not shown), such as when a user 185 uses an application operating on the user computing device (not shown) to access or obtain permission to operate an autonomous LEV 105, such as for a short-term rental of the autonomous LEV 105. In some implementations, a fully autonomous mode can be disabled when a human operator is present.

In some implementations, the remote computing system 190 can communicate indirectly with the autonomous LEV 105. For example, the remote computing system 190 can obtain and/or communicate data to and/or from a third party computing system, which can then obtain/communicate data to and/or from the autonomous LEV 105. The third party computing system can be, for example, the computing system of an entity that manages, owns, operates, etc. one or more autonomous LEVs. The third party can make their autonomous LEV(s) available on a network associated with the remote computing system 190 (e.g., via a platform) so that the autonomous vehicles LEV(s) can be made available to user(s) 185.

The LEV computing system 100 can include one or more computing devices located onboard the autonomous LEV 105. For example, the computing device(s) can be located on and/or within the autonomous LEV 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the autonomous LEV 105 (e.g., its computing system, one or more processors, etc.) to perform operations and functions, such as those described herein for determining navigational instructions for the autonomous LEV 105, etc.

The autonomous LEV 105 can include a communications system 110 configured to allow the LEV computing system 100 (and its computing device(s)) to communicate with other computing devices. The LEV computing system 100 can use the communications system 110 to communicate with one or more computing device(s) that are remote from the autonomous LEV 105 over one or more networks (e.g., via one or more wireless signal connections). For example, the communications system 110 can allow the autonomous LEV to communicate and receive data from a remote computing system 190 of a service entity (e.g., an autonomous LEV rental entity), a third party computing system, and/or a user computing device (e.g., a user's smart phone). In some implementations, the communications system 110 can allow communication among one or more of the system(s) on-board the autonomous LEV 105. The communications system 110 can include any suitable components for interfacing with one or more network(s), including, for example, transmitters, receivers, ports, controllers, antennas, and/or other suitable components that can facilitate communication.

As shown in FIG. 1, the autonomous LEV 105 can include one or more vehicle sensors 120, an autonomy system 140, a repositioning system 150 (e.g., a component of an autonomy system 140 or a stand-alone repositioning system 150), one or more vehicle control systems 175, and other systems, as described herein. One or more of these systems can be configured to communicate with one another via a communication channel. The communication channel can include one or more data buses (e.g., controller area network (CAN)), on-board diagnostics connector (e.g., OBD-II), Ethernet, and/or a combination of wired and/or wireless communication links. The onboard systems can send and/or receive data, messages, signals, etc. amongst one another via the communication channel.

The vehicle sensor(s) 120 can be configured to acquire sensor data 125. The vehicle sensor(s) 120 can include a Light Detection and Ranging (LIDAR) system, a Radio Detection and Ranging (RADAR) system, one or more cameras (e.g., fisheye cameras, visible spectrum cameras, infrared cameras, etc.), ultrasonic sensors, wheel encoders (e.g., wheel odometry sensors), steering angle encoders, positioning sensors (e.g., GPS sensors), accelerometers, inertial measurement units (which can include one or more accelerometers and/or gyroscopes), radio beacon sensors (e.g., Bluetooth low energy sensors), motion sensors, inertial sensors, and/or other types of imaging capture devices and/or sensors. The sensor data 125 can include inertial measurement unit/accelerometer data, image data, RADAR data, LIDAR data, radio beacon sensor data, GPS sensor data, and/or other data acquired by the vehicle sensor(s) 120. This can include sensor data 125 associated with the surrounding environment of the autonomous LEV 105. For example, a fisheye camera can be a forward-facing fisheye camera, and can be configured to obtain image data which includes one or more portions of the autonomous LEV 105 and the orientation and/or location of the one or more portions of the autonomous LEV 105 in the surrounding environment. The sensor data 125 can also include sensor data 125 associated with the autonomous LEV 105. For example, the autonomous LEV 105 can include inertial measurement unit(s) (e.g., gyroscopes and/or accelerometers), wheel encoders, steering angle encoders, and/or other sensors.

In addition to the sensor data 125, the LEV computing system 100 can retrieve or otherwise obtain map data 130. The map data 130 can provide information about the surrounding environment of the autonomous LEV 105. In some implementations, an autonomous LEV 105 can obtain detailed map data that provides information regarding: the identity and location of different walkways, walkway sections, and/or walkway properties (e.g., spacing between walkway cracks); the identity and location of different radio beacons (e.g., Bluetooth low energy beacons); the identity and location of different position identifiers (e.g., QR codes visibly positioned in a geographic area); the identity and location of different LEV designated parking locations; the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); the location of collection points (e.g., LEV fleet pickup/dropoff locations); the location of charging stations; a rider location (e.g., the location of a rider requesting an autonomous LEV 105); supply positioning locations (e.g., locations for the autonomous LEV 105 to be located when not in use in anticipation of demand); and/or any other map data that provides information that assists the autonomous LEV 105 in comprehending and perceiving its surrounding environment and its relationship thereto. In some implementations, the LEV computing system 100 can determine a vehicle route for the autonomous LEV 105 based at least in part on the map data 130.

In some implementations, the map data 130 can include an image map, such as an image map generated based at least in part on a plurality of images of a geographic area. For example, in some implementations, an image map can be generated from a plurality of aerial images of a geographic area. For example, the plurality of aerial images can be obtained from above the geographic area by, for example, an air-based camera (e.g., affixed to an airplane, helicopter, drone, etc.). In some implementations, the plurality of images of the geographic area can include a plurality of street view images obtained from a street-level perspective of the geographic area. For example, the plurality of street-view images can be obtained from a camera affixed to a ground-based vehicle, such as an automobile. In some implementations, the image map can be used by a visual localization model to determine a location of an autonomous LEV 105.

The repositioning system 150 can obtain/receive the sensor data 125 from the vehicle sensor(s), and determine one or more navigational instructions for the autonomous LEV 105. In some implementations, the repositioning system 150 can determine a location (also referred to as a position) of the autonomous LEV 105. For example, the repositioning system 150 can use GPS data, map data, radio beacon data, or other positioning data to determine the position of the autonomous LEV 105. In some implementations, the repositioning system 150 can determine one or more navigational instructions for the autonomous LEV 105 without first determining a position of the autonomous LEV 105.

The repositioning system 150 can be any device or circuitry for determining one or more navigational instructions for the autonomous LEV 105. As shown, in some implementations, the repositioning system 150 can be included in or otherwise a part of an autonomy system 140. In some implementations, a repositioning system 150 can be a standalone repositioning system 150. Additionally, as shown in FIG. 1, in some implementations, a remote computing system 190 can include a repositioning system 150. For example, sensor data 125 (e.g., image data) from one or more sensors 120 of an autonomous LEV 105 can be communicated to the remote computing system 190 via the communications system 110, such as over a communications network.

According to example aspects of the present disclosure, the repositioning system 150 can determine one or more navigational instructions for the autonomous LEV 105 based at least in part on the sensor data 125 obtained from the vehicle sensor(s) 120 located onboard the autonomous LEV 105. In some implementations, the repositioning system 150 can use various models, such as purpose-built heuristics, algorithms, machine-learned models, etc. to determine the one or more navigational instructions. The various models can include computer logic utilized to provide desired functionality. For example, in some implementations, the models can include program files stored on a storage device, loaded into a memory and executed by one or more processors. In other implementations, the models can include one or more sets of computer-executable instructions that are stored in a tangible computer-readable storage medium such as RAM hard disk, flash storage, or optical or magnetic media. In some implementations, the one or more models can include machine-learned models, such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

For example, in some implementations, the repositioning system 150 can include an image segmentation and classification model 151. The image segmentation model 151 can segment or partition an image into a plurality of segments, such as, for example, a foreground, a background, a walkway, sections of a walkway, roadways, various objects (e.g., vehicles, people, trees, benches, tables, etc.), or other segments.

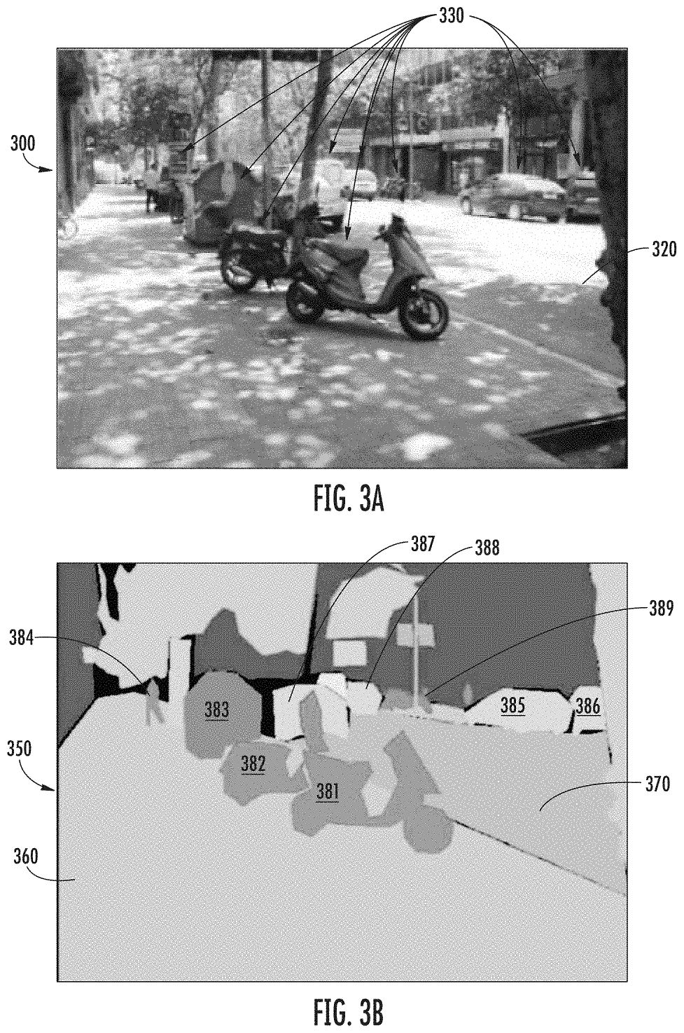

In some implementations, the image segmentation and classification model 151 can be trained using training data comprising a plurality of images labeled with various objects and aspects of each image. For example, a human reviewer can annotate a training dataset which can include a plurality of images with ground planes, walkways, sections of a walkway, roadways, various objects (e.g., vehicles, people, trees, benches, tables), etc. The human reviewer can segment and annotate each image in the training dataset with labels corresponding to each segment. For example, walkways and/or walkway sections (e.g., frontage zone, furniture zone, a pedestrian throughway, bicycle lane) in the images in the training dataset can be labeled, and the image segmentation and classification model 151 can be trained using any suitable machine-learned model training method (e.g., back propagation of errors). Once trained, the image segmentation and classification model 151 can receive an image, such as an image from a fisheye camera located onboard an autonomous LEV 105, and can segment the image into corresponding segments. An example of an image segmented into objects, roads, and a walkway using an example image segmentation and classification model 151 is depicted in FIGS. 3A and 3B.

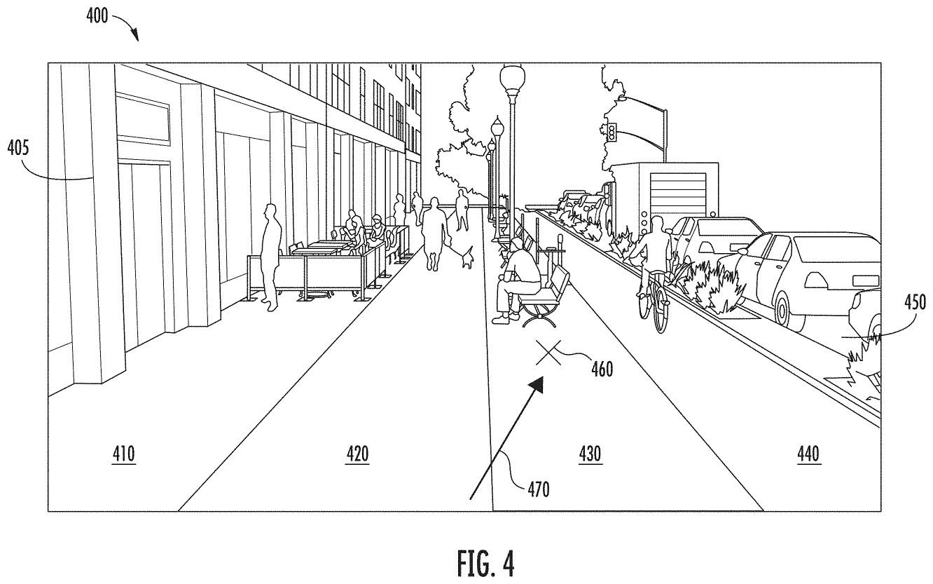

In some implementations, the repositioning system 150 can include a ground plane analysis model 152. For example, an image can be segmented using an image segmentation and classification model 151, and a ground plane analysis model 152 can determine which segments of the image correspond to a ground plane (e.g., a navigable surface on which the autonomous LEV can travel). The ground plane analysis model 152 can be trained to detect a ground plane in an image, and further, to determine various properties of the ground plane, such as relative distances between objects positioned on the ground plane, which parts of a ground plane are navigable (e.g., can be travelled on), and other properties. In some implementations, the ground plane analysis model 152 can be included in or otherwise a part of an image segmentation and classification model 151. In some implementations, the ground plane analysis model 152 can be a stand-alone ground plane analysis model 152, such as a lightweight ground plane analysis model 152 configured to be used onboard the autonomous LEV 105. Example images with corresponding ground planes are depicted in FIGS. 3A, 3B, and 4.

In some implementations, the repositioning system 150 can use walkway detection model 153 to determine that the autonomous LEV 105 is located on a walkway or to detect a walkway nearby. For example, the repositioning system 150 can use accelerometer data and/or image data to detect a walkway. For example, as the autonomous LEV 105 travels on a walkway, the wheels of the autonomous LEV 105 can travel over cracks in the walkway, causing small vibrations to be recorded in the accelerometer data. The repositioning system 150 can analyze the accelerometer data for a walkway signature waveform. For example, the walkway signature waveform can include periodic peaks repeated at relatively regular intervals, which can correspond to the acceleration caused by travelling over the cracks. In some implementations, the repositioning system 150 can determine that the autonomous LEV 105 is located on a walkway by recognizing the walkway signature waveform. In some implementations, the walkway detection model 153 can use map data 130, such as map data 130 which can includes walkway crack spacing data, to detect the walkway. In some implementations, the walkway detection model 153 can use speed data to detect the walkway, such as speed data obtained via GPS data, wheel encoder data, speedometer data, or other suitable data indicative of a speed.

In some implementations, the walkway detection model 153 can determine that the autonomous LEV 105 is located on or near a walkway based at least in part on one or more images obtained from a camera located onboard the autonomous LEV 105. For example, an image can be segmented using an image segmentation and classification model 151, and the walkway detection model 153 can be trained to detect a walkway or walkway sections. In some implementations, the walkway detection model 153 can be included in or otherwise a part of an image segmentation and classification model 151. In some implementations, the walkway detection model 153 can be a stand-alone walkway detection model 153, such as a lightweight walkway detection model 153 configured to be used onboard the autonomous LEV 105. An example image with a walkway segmented into a plurality of sections is depicted in FIG. 4.

In some implementations, the walkway detection model 153 can determine that the autonomous LEV is located on a walkway and/or a particular walkway section based on the orientation of the walkway and/or walkway sections in an image. For example, in some implementations, an image captured from a fisheye camera can include a perspective view of the autonomous LEV 105 located on the walkway or show the walkway on both a left side and a right side of the autonomous LEV 105, and therefore indicate that the autonomous LEV 105 is located on the walkway (and/or walkway section).

The repositioning system 150 can also include an orientation analysis model 154. The orientation analysis model 154 can be configured to determine whether the autonomous LEV 105 is in a lying down orientation or an upright orientation. For example, in some implementations, the orientation analysis model 154 can use inertial measurement data (e.g., accelerometer data) to determine the orientation of the autonomous LEV 105. In some implementations, the orientation analysis model 154 can use image data to determine the orientation of the autonomous LEV 105. For example, an image segmentation and classification model 151 and/or a ground plane analysis model 152 can determine an orientation of a ground plane relative to the autonomous LEV 105. If the ground plane in the image is angled to one side or the other (e.g., not directly underneath the autonomous LEV 105 on both sides of the autonomous LEV 105, but rather only on a left or right side of the image), the orientation analysis model 154 can determine that the autonomous LEV 105 is in a lying down orientation.

The repositioning system 150 can also include a fiducial recognition model 155. For example, the fiducial recognition model 155 can be configured to recognize a fiducial path. For example, a fiducial path can include various painted lines, wires, magnetic strips, beacons, or other fiducial markers to mark the fiducial path. The fiducials used to mark a fiducial path can include any suitable marker, such as a high contrast (e.g., black/white, binary (yes/no), etc.) type marker. The fiducial path can correspond to a predetermined travel route for the autonomous LEV 105 to travel on. For example, a downtown area may include one or more bike paths, and a bike path can include a magnetic strip positioned along the bike path. The fiducial recognition model 155 can be configured to recognize the magnetic strip along the bike path. An advantage provided by the fiducial recognition model 155 is the ability to determine and detect a fiducial path onboard the autonomous LEV 105 with little computational analysis.

The repositioning system 150 can also include a navigation model 156. The navigational model 156 can be configured to determine one or more navigational instructions for the autonomous LEV 105. The one or more navigational instructions can be used by the autonomous LEV 105 for autonomous travel.

In some implementations, the one or more navigational instructions can include one or more dead-reckoning instructions, vector-based instructions, and/or waypoints. The one or more navigational instructions can essentially be a trajectory through space, and can use local coordinates relative to the autonomous LEV 105. In some implementations, the one or more navigational instructions can be determined agnostic of a determination of the current position of the autonomous LEV 105. For example, the one or more navigational instructions can be one or more directions relative to the current position of the autonomous LEV 105. As an example, the one or more navigational instructions can include a direction to travel (e.g. a heading) and a distance to travel relative to the current position of the autonomous LEV 105.

In some implementations, the navigation model 156 can determine one or more navigational instructions to travel to a particular location and/or towards the particular location. As an example, the one or more navigational instructions can include one or more navigational instructions associated with repositioning the autonomous LEV 105 at a LEV designated parking location, a LEV charging station, a LEV collection point, a LEV rider location, and/or a LEV supply positioning location. In some implementations, the navigation model 156 can simulate the implementation of the one or more navigational instructions by the autonomous LEV 105 to analyze the one or more navigational instructions.

In some implementations, the one or more navigational instructions can include all navigational instructions for autonomously travelling to the particular location. For example, the one or more navigational instructions can include instructions to navigate to a fiducial path, instructions to follow the fiducial path, and instructions to travel from the fiducial path to the particular location.

In some implementations, the one or more navigational instructions can include a portion of navigational instructions to navigate towards the particular location. For example, the one or more navigational instructions may only be for a limited time period, such as a 30 second travel window, and upon completion of the one or more navigational instructions or the time period elapsing, subsequent navigational instructions can be determined, such as using subsequently obtained sensor data.

For example, the repositioning system 150 can use the image segmentation and classification model 151 to identify a LEV charging location depicted in an image. In some implementations, additional data, such as map data 130, can be used to determine a general area in which an image which may include the LEV charging station should be obtained. The ground plane analysis model 152 can then analyze the image to determine a drivable surface of the image, and relative distances between objects and/or the autonomous LEV 105.

The navigation model 156 can then determine one or more navigational instructions to navigate to the particular location, such as the LEV charging station. For example, the navigation model can determine a particular direction or heading (e.g., southeast) and a distance to travel (e.g., 10 meters). The one or more navigational instructions can then be implemented by the vehicle control system 175. For example, the autonomy system 140 and/or the vehicle control system 175 of the autonomous LEV 105 can cause the autonomous LEV to initiate travel based at least in part on the one or more navigational instructions by sending appropriate control signals to vehicle control components (e.g., steering actuators, drive wheels, etc.) to travel in the direction and for the distance indicated by the one or more navigational instructions.

In some implementations, the walkway detection model 153 can be used to determine an authorized section of a travel way in which the autonomous LEV 105 is permitted to travel. For example, the walkway detection model 153 can analyze the ground plane to identify various sections of a travelway (e.g., a bicycle lane section of a sidewalk), and the navigation model 156 can determine one or more navigational instructions for the autonomous LEV 105 to travel in the authorized section of the travel way. For example, the one or more navigational instructions can include one or more navigational instructions for the autonomous LEV 105 to travel to the authorized travelway and, further, to travel along the authorized travelway.

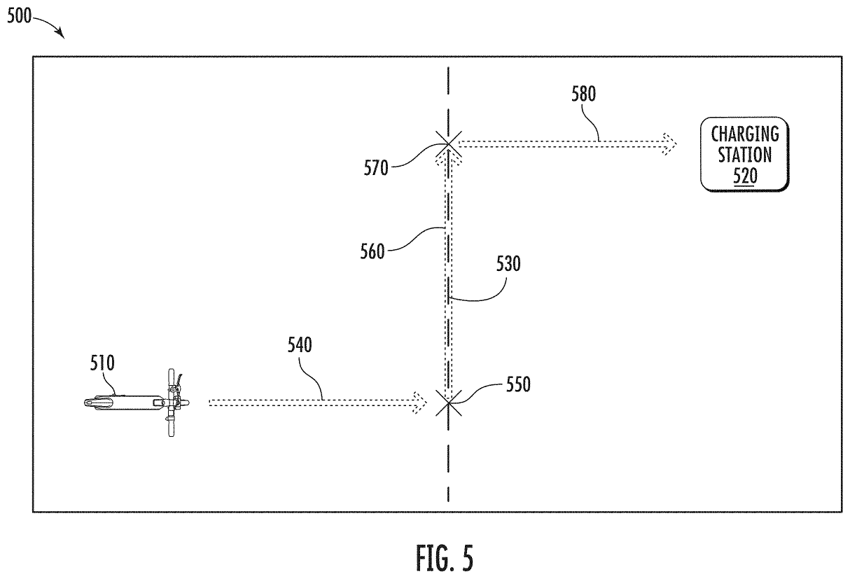

In some implementations, the one or more navigational instructions determined by the navigation model 156 can include one or more navigational instructions to travel to a fiducial path. For example, an image segmentation classification model 151, a ground plane analysis model 152, and/or a walkway detection model 153 can be used to detect a fiducial path depicted in an image. For example, a bicycle lane which includes a magnetic strip can be identified in an image, and the navigation model 156 can determine one or more navigational instructions to navigate to the fiducial path. Further, the one or more navigational instructions can include one or more navigational instructions to travel along at least a portion of the fiducial path. For example, the autonomous LEV 105 can travel according to one or more navigational instructions to a fiducial path, and once the fiducial path has been detected, such as by a fiducial recognition model 155, the autonomous LEV 105 can travel along the fiducial path according to the one or more navigational instructions. In some implementations, the one or more navigational instructions can further include one or more navigational instructions to travel from the fiducial path to a particular location. For example, the autonomous LEV 105 can travel to the fiducial path, along the fiducial path, and then leave the fiducial path to travel to a desired location, such as a LEV charging station. An example of a fiducial path based navigation of an autonomous LEV 105 according to example aspects of the present disclosure is discussed in greater detail with respect to FIG. 5.

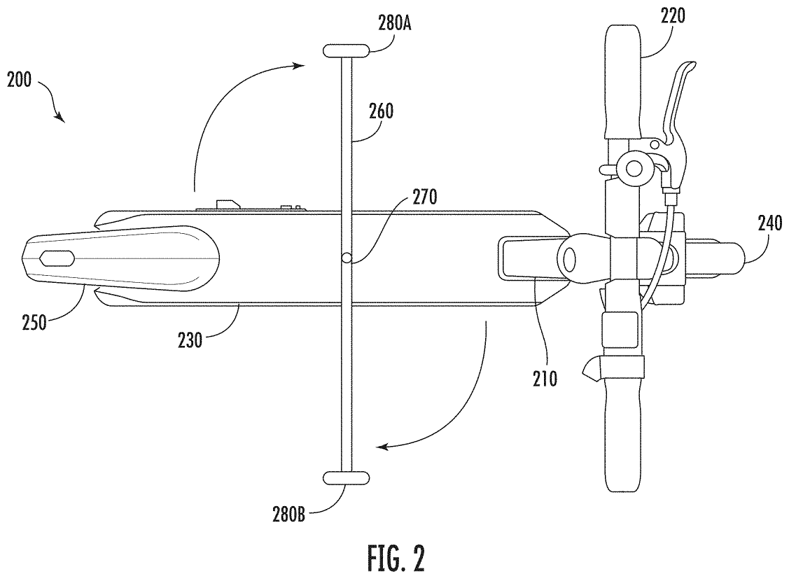

In some situations, the repositioning system 150 may determine that the autonomous LEV 105 is in a lying down orientation. For example, the orientation analysis model 154 may determine that the autonomous LEV 105 is in the lying down orientation, and thus unable to travel until the autonomous LEV 105 is in an upright orientation. According to additional example aspects of the present disclosure, the repositioning system 150 can control the autonomous LEV 105 into the upright orientation using an orientation adjustment device 176. The orientation adjustment device 176 can be, for example, a device configured to control the autonomous LEV 105 from a lying down orientation to an upright orientation. For example, in various implementations, an orientation adjustment device can include a rotating kickstand, an inertia based orientation adjustment device, such as a gyroscope or flywheel, or any other device configured to cause the autonomous LEV 105 to stand up from a lying down orientation to an upright orientation. An example orientation adjustment device 176 according to example aspects of the present disclosure is discussed in greater detail with respect to FIG. 2.

In some implementations, the repositioning system 150 can include a state estimator 160. For example, the state estimator can be configured to receive sensor data from a plurality of sensors and/or models 151-156 to determine the one or more navigational instructions for the autonomous LEV 105. In some implementations, the state estimator 160 can be or otherwise include a Kalman filter 161.

For example, the state estimator 160 can be used to help determine and/or implement the one or more navigational instructions. As an example, data from various sensors onboard the autonomous LEV 105, such as a wheel odometry sensor, a camera, an inertial measurement unit/sensor (IMU), and/or a steering angle encoder, can be used by the state estimator 160 to track the travel of the autonomous LEV 105 as the autonomous LEV 105 travels in accordance with the one or more navigational instructions.

In some implementations, the repositioning system 150 can obtain a second set of data, such as after traveling in accordance with a first set of navigational instructions. For example, as described herein, the repositioning system 150 can obtain sensor data and determine one or more navigational instructions based at least in part on the sensor data. Further, the autonomous LEV 105 can travel according to the one or more navigational instructions. For example, the autonomous LEV 105 can travel a particular distance in a particular direction. Upon completing least a portion of travel according to the one or more navigational instructions, the autonomous LEV 105 can obtain subsequent sensor data. For example, the subsequent sensor data (e.g., a second image) can be obtained as the vehicle is traveling and/or the subsequent sensor data can be obtained upon completion of travel. Further, the repositioning system 150 can determine whether the autonomous LEV 105 has traveled to a particular location based at least in part on the subsequent sensor data. For example, a first image can be used to determine one or more navigational instructions to a designated parking location, and a second image can be obtained to confirm that the autonomous LEV 105 has traveled to the designated parking location. If, however, the autonomous LEV 105 has not traveled to the particular location (e.g., the designated parking location), the repositioning system 150 can determine one or more subsequent navigational instructions based at least in part on the subsequent sensor data. For example, the repositioning system 105 can use the various models 151-156 to determine one or more subsequent navigational instructions to travel to the particular location. The autonomous LEV 105 can then travel based at least in part on the one or more subsequent navigational instructions. In this way, the autonomous LEV 105 can iteratively obtain sensor data, determine navigational instructions based at least in part on the sensor data, and travel in accordance with the one or more navigational instructions.

The LEV computing system 100 can also include an autonomy system 140. As noted, in some implementations, the repositioning system 150 can be included as a part of the autonomy system 140. In some implementations, the autonomy system 140 can obtain the sensor data 125 from the vehicle sensor(s) 120 to perceive its surrounding environment, predict the motion of objects within the surrounding environment, and generate an appropriate motion plan through such surrounding environment.

The autonomy system 140 (and/or the repositioning system 150) can communicate with the one or more vehicle control systems 175 to operate the autonomous LEV 105 according to the one or more navigational instructions. As an example, the one or more vehicle control systems 175 can control a steering actuator to orient the autonomous LEV 105 in a particular direction and can power one or more drive wheels to travel a particular distance.

In some implementations, the autonomy system 140 can receive the one or more navigational instructions from a remote computing system 190, and the vehicle control system 175 can operate the autonomous LEV 105 according to the one or more navigational instructions. As noted, the vehicle control system 175 can include an orientation adjustment device 176 to control the autonomous LEV 105 from a lying down orientation to an upright orientation.

In some implementations, the autonomous LEV 105 can use additional sensor data while travelling according to the one or more navigational instructions. For example, the autonomous LEV 105 can use short-range ultrasonic sensor data to help ensure the autonomous LEV 105 does not bump into anything in front of the autonomous LEV 105 while travelling according to the one or more navigational instructions.

The autonomous LEV 105 can include an HMI (“Human Machine Interface”) 180 that can output data for and accept input from a user 185 of the autonomous LEV 105. The HMI 180 can include one or more output devices such as display devices, speakers, tactile devices, etc. In some implementations, the HMI 180 can provide notifications to a rider, such as when a rider is violating a walkway restriction.

The remote computing system 190 can include one or more computing devices that are remote from the autonomous LEV 105 (e.g., located off-board the autonomous LEV 105). For example, such computing device(s) can be components of a cloud-based server system and/or other type of computing system that can communicate with the LEV computing system 100 of the autonomous LEV 105, another computing system (e.g., a vehicle provider computing system, etc.), a user computing system (e.g., rider's smartphone), etc. The remote computing system 190 can be or otherwise included in a data center for the service entity, for example. The remote computing system 190 can be distributed across one or more location(s) and include one or more sub-systems. The computing device(s) of a remote computing system 190 can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system (e.g., the one or more processors, etc.) to perform operations and functions, such as communicating data to and/or obtaining data from vehicle(s), and determining one or more navigational instructions for an autonomous LEV 105.

As shown in FIG. 1, the remote computing system 190 can include a repositioning system 150, as described herein. In some implementations, the remote computing system 190 can determine one or more navigational instructions for the autonomous LEV 105 based at least in part on sensor data 125 communicated from the autonomous LEV 105 to the remote computing system 190.

For example, in some implementations, an autonomous LEV 105 can upload sensor data (e.g., image data) to the remote computing system 190. The remote computing system 190, and more particularly, the repositioning system 150, can then determine one or more navigational instructions for the autonomous LEV 105 based at least in part on the uploaded sensor data.

In some implementations, the repositioning system 150 can determine a particular location to reposition the autonomous LEV 105 based at least in part on the sensor data. In some implementations, the repositioning system 150 can determine the particular location to reposition the autonomous LEV 105 without any human input. For example, the repositioning system 150 can determine that the autonomous LEV 105 is parked in an unauthorized area by analyzing uploaded image data using one or more models 151-156. Further, the repositioning system 150 can detect (e.g., identify) a designated parking location depicted in the uploaded image data. For example, the designated parking location can be a painted parking spot or an authorized parking section of a walkway (e.g., a furniture zone). The repositioning system 150 can then determine one or more navigational instructions for the autonomous LEV 105 to travel to the particular location (e.g., the designated parking location).

In some implementations, the remote computing system 190 can communicate one or more commands to an autonomous LEV 105 to attempt to detect (e.g., look for/identify) a fiducial path in a surrounding environment of the autonomous LEV 105. As an example, an autonomous LEV 105 may be located in an area near a fiducial path, and the remote computing system 190 can communicate data indicative of the fiducial path (e.g., a unique identifier associated with a fiducial, a type of fiducial, etc.) to the autonomous LEV 105. The autonomous LEV 105 can then use sensor data 125 (e.g., image data, radio beacon data, etc.) to detect the fiducial path. The one or more commands to look for the fiducial path can be included, for example, in one or more navigational instructions to travel to and/or along the fiducial path communicated from the remote computing system 190 to the autonomous LEV 105. The autonomous LEV 105 can then navigate to and along the fiducial path to autonomously reposition the autonomous LEV 105.

In some implementations, the one or more navigational instructions can be determined based at least in part on a user input. For example, the remote computing system 190 can be associated with a teleoperator. The remote computing system 190 can include a display 160 configured to display image data uploaded from an autonomous LEV 105. The teleoperator can then view the uploaded image data on the display 160, and can select a particular location depicted in the image for the autonomous LEV 105 to travel to. For example, in some implementations, the teleoperator can provide teleoperator input 161 indicative of the particular location by clicking on an area in the image corresponding to the particular location. For example, the teleoperator can click on a designated parking location, and the repositioning system 150 can then determine one or more navigational instructions for the autonomous LEV 105 to travel to the designated parking location, as described herein. In this way, the repositioning system 150 can determine one or more navigational instructions to travel to a particular location based at least in part on sensor data obtained from on board an autonomous LEV 105 and teleoperator input.

In some implementations, the remote computing system 190 can simulate the implementation of the one or more navigational instructions by the autonomous LEV 105 to analyze the one or more navigational instructions. For example, a remote teleoperator can provide teleoperator input 161, and the remote computing system can use the repositioning system 150 to simulate one or more possible navigational instructions to travel to the particular destination indicated by the teleoperator input 161. The repositioning system can then select one of the one or more navigational instructions, such as a set of navigational instructions which provided the best simulation results.

Once the remote computing system 190 has determined the one or more navigational instructions for the autonomous LEV 105, the remote computing system 190 can communicate the one or more navigational instructions to the autonomous LEV 105. For example, in some implementations, a file (e.g., a text file) can be communicated which can include the one or more navigational instructions, such as vector-based instructions, waypoints, dead-reckoning instructions, instructions to follow a fiducial path, and/or other navigational instructions.

Referring now to FIG. 2, a top-down perspective of an example autonomous LEV 200 according to example aspects of the present disclosure is depicted. For example, the autonomous LEV 200 depicted is an autonomous scooter. The autonomous LEV 200 can correspond to an autonomous LEV 105 depicted in FIG. 1.

As shown, the autonomous LEV 200 can include a steering column 210, a handlebar 220, a rider platform 230, a front wheel 240 (e.g., steering wheel), and a rear wheel 250 (e.g., drive wheel). For example, a rider can operate the autonomous LEV 200 in a manual mode in which the rider stands on the rider platform 230 and controls operation of the autonomous LEV 200 using controls on the handlebar 220. The autonomous LEV 200 can include various other components (not shown), such as sensors, actuators, batteries, computing devices, communication devices, and/or other components as described herein.

According to additional aspects of the present disclosure, the autonomous LEV 200 can further include an orientation adjustment device. For example, in some implementations, the orientation adjustment device can be a rotating kickstand 260. For example, the rotating kickstand 260 can be pivotably connected to the rider platform 230 at an axis 270. In some implementations, the axis 270 can be powered. For example, a motor, such as a geared-down electric motor connected to a battery, can be configured to rotate the rotating kickstand 260 about the axis 270. Further, one or more wheels 280A-B can be connected at each end of the rotating kickstand 260 to allow for reduced friction with the ground as the rotating kickstand 260 rotates about the axis 270.

For example, upon determining that the autonomous LEV 200 is in a lying down orientation, a computing system (e.g., a computing device onboard the autonomous LEV 200 or a remote computing device) can control the rotating kickstand 260 to rotate about the axis 270 such that the rotating kickstand 260 rotates to an essentially perpendicular orientation with the rider platform 230. For example, a control signal can be sent to the geared down motor causing the geared down motor to rotate the rotating kickstand 260. As the rotating kickstand 260 rotates (as shown by the arrows), the autonomous LEV 200 can stand up from the lying down orientation to an upright orientation.

Once in the upright position, the rotating kickstand 260 can rotate back to a parallel orientation with the rider platform 230. For example, the rotating kickstand 260 can fold up underneath the rider platform 230. In this way, the autonomous LEV 200 can be controlled from the lying down orientation to an upright orientation to allow for autonomous travel.

In some implementations, the rotating kickstand 260 can be used to help steer the autonomous LEV 200, such as during autonomous operation. For example, rotating the rotating kickstand 260 one way or the other can cause the autonomous LEV 200 to turn. In some implementations, the rotating kickstand 260 can be used in conjunction with another steering control system, such as a steering actuator at the steering column 210, to steer the autonomous LEV 200. Further, the rotating kickstand 260 can provide additional stability to the autonomous vehicle during autonomous operation by helping to balance the autonomous LEV 200 in the upright position.

Referring now to FIG. 3A, an example image 300 depicting a walkway 310, a street 320, and a plurality of objects 330 is depicted, and FIG. 3B depicts a corresponding semantic segmentation 350 of the image 300. For example, as shown, the semantically-segmented image 350 can be partitioned into a plurality of segments 360-389 corresponding to different semantic entities depicted in the image 300. Each segment 360-389 can generally correspond to an outer boundary of the respective semantic entity. For example, the walkway 310 can be semantically segmented into a distinct semantic entity 360, the road 320 can be semantically segmented into a distinct semantic entity 370, and each of the objects 330 can be semantically segmented into distinct semantic entities 381-389, as depicted. For example, semantic entities 381-384 are located on the walkway 360, whereas semantic entities 385-389 are located on the road 370. While the semantic segmentation depicted in FIG. 3 generally depicts the semantic entities segmented to their respective borders, other types of semantic segmentation can similarly be used, such as bounding boxes etc.

In some implementations, individual sections of a walkway 310 and/or a ground plane can also be semantically segmented. For example, an image segmentation and classification model 151, a ground plane analysis model 152, and/or a walkway detection model 153 depicted in FIG. 1 can be trained to semantically segment an image into one or more of a ground plane, a road, a walkway, etc. For example, a ground plane can include a road 370 and a walkway 360. Further, in some implementations, the walkway 360 can be segmented into various sections, as described in greater detail with respect to FIG. 4.

Referring now to FIG. 4, an example walkway 400 and walkway sections 410-440 according to example aspects of the present disclosure are depicted. As shown, a walkway 400 can be divided up into one or more sections, such as a first section (e.g., frontage zone 410), a second section (e.g., pedestrian throughway 420), a third section (e.g., furniture zone 430), and/or a fourth section (e.g., travel lane 440). The walkway 400 depicted in FIG. 4 can be, for example, a walkway depicted in an image obtained from a camera onboard an autonomous LEV, and thus from the perspective of the autonomous LEV.

A frontage zone 410 can be a section of the walkway 400 closest to one or more buildings 405. For example, the one or more buildings 405 can correspond to dwellings (e.g., personal residences, multi-unit dwellings, etc.), retail space (e.g., office buildings, storefronts, etc.) and/or other types of buildings. The frontage zone 410 can essentially function as an extension of the building, such as entryways, doors, walkway cafés, sandwich boards, etc. The frontage zone 410 can include both the structure and the facade of the buildings 405 fronting the street 450 as well as the space immediately adjacent to the buildings 405.

The pedestrian throughway 420 can be a section of the walkway 400 that functions as the primary, accessible pathway for pedestrians that runs parallel to the street 450. The pedestrian throughway 420 can be the section of the walkway 400 between the frontage zone 410 and the furniture zone 430. The pedestrian throughway 420 functions to help ensure that pedestrians have a safe and adequate place to walk. For example, the pedestrian throughway 420 in a residential setting may typically be 5 to 7 feet wide, whereas in a downtown or commercial area, the pedestrian throughway 420 may typically be 8 to 12 feet wide. Other pedestrian throughways 420 can be any suitable width.

The furniture zone 430 can be a section of the walkway 400 between the curb of the street 450 and the pedestrian throughway 420. The furniture zone 430 can typically include street furniture and amenities such as lighting, benches, newspaper kiosks, utility poles, trees/tree pits, as well as light vehicle parking spaces, such as designated parking spaces for bicycles and LEVs.

Some walkways 400 may optionally include a travel lane 440. For example, the travel lane 440 can be a designated travel way for use by bicycles and LEVs. In some implementations, a travel lane 440 can be a one-way travel way, whereas in others, the travel lane 440 can be a two-way travel way. In some implementations, a travel lane 440 can be a designated portion of a street 450.

Each section 410-440 of a walkway 400 can generally be defined according to its characteristics, as well as the distance of a particular section 410-440 from one or more landmarks. For example, in some implementations, a frontage zone 410 can be the 6 to 8 feet closest to the one or more buildings 405. In some implementations, a furniture zone 430 can be the 6 to 8 feet closest to the street 450. In some implementations, the pedestrian throughway 420 can be the 5 to 12 feet in the middle of a walkway 400. In some implementations, each section 410-440 can be determined based upon characteristics of each particular section 410-440, such as by semantically segmenting an image using an image segmentation and classification model 151, a ground plane analysis model 152, and/or a walkway detection model 153 depicted in FIG. 1. For example, street furniture included in a furniture zone 430 can help to distinguish the furniture zone 430, whereas sandwich boards and outdoor seating at walkway cafés can help to distinguish the frontage zone 410. In some implementations, the sections 410-440 of a walkway 400 can be defined, such as in a database. For example, a particular location (e.g., a position) on a walkway 400 can be defined to be located within a particular section 410-440 of the walkway 400 in a database, such as a map data 130 database depicted in FIG. 1. In some implementations, the sections 410-440 of a walkway 400 can have general boundaries such that the sections 410-440 may have one or more overlapping portions with one or more adjacent sections 410-440.

According to example aspects of the present disclosure, in some implementations, a computing system can determine a particular location 460 to reposition an autonomous LEV. For example, the particular location 460 can be a LEV designated parking location, a LEV charging station, a LEV collection point, a LEV rider location, or a LEV supply positioning location. As depicted in FIG. 4, the particular location 460 can be a designated parking location in a furniture zone 430 of a walkway 400. In some implementations, the particular location can be determined by a computing system, as described herein. In some implementations, a teleoperator can provide the particular location as an input. For example, the image depicted in FIG. 4 can be displayed on a display screen associated with the teleoperator, and the teleoperator can input the particular location, such as by clicking on the particular location on the display screen.

The computing system can then determine one or more navigational instructions for the autonomous LEV to travel to the particular location. For example, as depicted in FIG. 4, the one or more navigational instructions are represented as a travel vector 470. The travel vector 470 can indicate a direction of travel (e.g., a heading), and a distance to travel. As noted herein, other types of navigational instructions can similarly be used, such as dead-reckoning instructions, waypoint-based instructions, and/or other navigational instructions. The autonomous LEV can then travel according to the travel vector 470. In some implementations, the autonomous LEV can use one or more ultrasonic sensors while traveling along the travel vector 470 to help ensure the path in front of the autonomous LEV is clear. In some implementations, upon completing travel according to the travel vector 470, the computing system can obtain subsequent sensor data to confirm whether or not the autonomous LEV has traveled to the particular location 460. If not, one or more subsequent navigational instructions can be determined and the autonomous LEV can travel according to the one or more subsequent navigational instructions.

FIG. 5 depicts an example navigation of an autonomous LEV 510 along a fiducial path 530 according to additional aspects of the present disclosure. For example, as depicted, a computing system (e.g., an autonomous LEV 510 computing system and/or a remote computing system) can determine that the autonomous LEV 510 is to be repositioned at a charging station 520. For example, a battery onboard the autonomous LEV 510 may have a battery charge level which is below a threshold, and therefore the computing system can determine that the autonomous LEV 510 needs to be charged at the charging station 520. In some implementations, a remote computing system can communicate one or more commands to the autonomous LEV 510 to attempt to detect (e.g., look for/identify) the fiducial path 530, as described herein.

In some implementations, the computing system can determine a first navigational instruction 540 to travel to the fiducial path 530. For example, the first navigational instruction 540 can be a dead-reckoning instruction, vector-based instruction, and/or waypoint-based instruction to travel to a first waypoint 550 along the fiducial path 530.

Additionally, the computing system can determine a second navigational instruction 560 to travel along the fiducial path 530. For example, the autonomous LEV 510 can travel to a second location 570 along the fiducial path 530. The fiducial path 530 can include various painted lines, wires, magnetic strips, beacons, or other fiducial markers to mark the fiducial path 530. The fiducials used to mark a fiducial path 530 can include any suitable marker, such as a high contrast (e.g., black/white, binary (yes/no), etc.) type marker. The fiducial path 530 can correspond to a predetermined, authorized travel route for the autonomous LEV 510, and the autonomous LEV 510 can use a fiducial recognition model onboard the autonomous LEV 510 to recognize and travel along the fiducial path 530 without expending significant computational resources.

The second navigational instruction 560 can be, for example, a dead-reckoning instruction, vector-based instruction, and/or waypoint-based instruction to travel to the second waypoint 570 on the fiducial path 530. In various implementations, the autonomous LEV 510 can be configured to determine when the autonomous LEV 510 has reached the second waypoint 570 by, for example, recognizing a position marker along the fiducial path 530 or tracking a distance travelled along the fiducial path 530.

The computing system can determine a third navigational instruction 580 to travel from the second waypoint 570 to the charging station 520. For example, the third navigational instruction 580 can be a dead-reckoning instruction, vector-based instruction, and/or waypoint-based instruction to travel to the charging station 520. In some implementations, the computing system can determine the third instruction 580 prior to initiating travel, such as when the first instruction 540 is determined. In some implementations, the third instruction 580 can be determined by the computing system using sensor data obtained by the autonomous LEV 510 when the autonomous LEV 510 has traveled to the second waypoint 570.

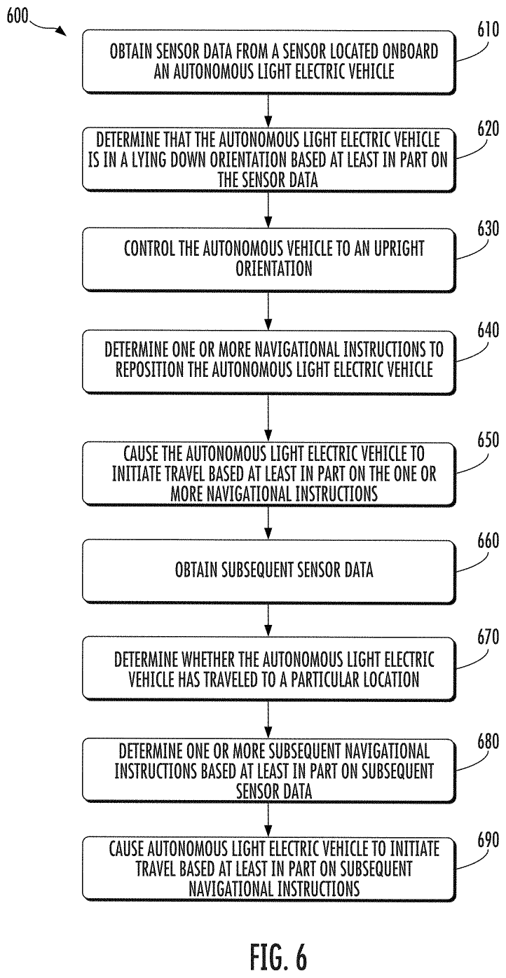

FIG. 6 depicts a flow diagram of an example method 600 for repositioning an autonomous LEV according to example aspects of the present disclosure. One or more portion(s) of the method 600 can be implemented by a computing system that includes one or more computing devices such as, for example, the computing systems described with reference to the other figures (e.g., a LEV computing system 100, a remote computing system 190, etc.). Each respective portion of the method 600 can be performed by any (or any combination) of one or more computing devices. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 6 is described with reference to elements/terms described with respect to other systems and figures for example illustrated purposes and is not meant to be limiting. One or more portions of method 600 can be performed additionally, or alternatively, by other systems.

At 610, the method 600 can include obtaining sensor data from a sensor located onboard an autonomous LEV. For example, in some implementations, an onboard computing system can obtain the sensor data directly from the sensors. In other implementations, an autonomous LEV can communicate the sensor data to a remote computing system. The sensors can be, for example, cameras, IMUS (e.g., accelerometers, gyroscopes, etc.), GPS sensors, RADAR sensors, LIDAR sensors, or other sensors, as disclosed herein.

At 620, the method 600 can include determining that the autonomous LEV is in a lying down orientation based at least in part on the sensor data. For example, image data or IMU data can be analyzed to determine an orientation of the autonomous LEV, such as whether the autonomous LEV is in an upright orientation or a lying down orientation.

At 630, the method 600 can include controlling the autonomous vehicle to an upright orientation. For example, an orientation adjustment device (e.g., a rotating kickstand, an inertia based orientation adjustment device, etc.) can control the autonomous LEV to stand up from a lying down orientation to an upright orientation.

At 640, the method 600 can include determining one or more navigational instructions to reposition the autonomous LEV. For example, in some implementations, the one or more navigational instructions can include one or more navigational instructions associated with repositioning the autonomous LEV at a LEV designated parking location, a LEV charging station, a LEV collection point, a LEV rider location, a LEV supply positioning location, or other location. The one or more navigational instructions can include dead-reckoning instructions, vector-based instructions, waypoint-based instructions, and/or other suitable navigational instructions.

In some implementations, the one or more navigational instructions can include determining an authorized section of a travel way in which the autonomous LEV is permitted to travel based at least in part on the sensor data. For example, a walkway detection model can determine a section of a walkway in which the autonomous LEV is permitted to travel. The one or more navigational instructions can then include navigational instructions to travel within the authorized section of the travel way.

In some implementations, the one or more navigational instructions can be determined onboard the autonomous LEV. For example, a computing device located onboard the autonomous LEV can analyze the sensor data to determine the one or more navigational instructions.

In some implementations, the one or more navigational instructions can be determined by a remote computing device. For example, the autonomous LEV can communicate sensor data (e.g., image data) from the autonomous LEV to a remote computing system. The remote computing system can then determine the one or more navigational instructions to reposition the autonomous LEV based at least in part on the uploaded sensor data. The remote computing system can then communicate the one or more navigational instructions to the autonomous LEV, such as over a communication network.

In some implementations, the one or more navigational instructions can be determined based at least in part on a teleoperator input. For example, uploaded image data can be displayed on a display screen associated with a teleoperator. The teleoperator can then select a particular location, such as by clicking on an area of the displayed image corresponding to the particular location. The remote computing system can then determine the one or more navigational instructions at least in part on a teleoperator input, such as by determining one or more navigational instructions to navigate to the location selected by the teleoperator. The remote computing system can then communicate the one or more navigational instructions to the autonomous LEV.

In some implementations, the one or more navigational instructions can include one or more navigational instructions to travel to a fiducial path and one or more navigational instructions to travel along the fiducial path. In some implementations, the one or more navigational instructions can further include one or more navigational instructions to travel from the fiducial path to a particular location.

At 650, the method 600 can include causing the autonomous light electric vehicle to initiate travel based at least in part on the one or more navigational instructions. For example, a vehicle control system can control the autonomous LEV to travel in the direction (e.g., a heading) for the distance indicated in the one or more navigational instructions.

At 660, the method 600 can include obtaining subsequent sensor data. For example, while traveling according to the one or more navigational instructions, upon completion of traveling according to the one or more navigational instructions, and/or upon the elapsing of a travel window (e.g., a 30 second travel window), the autonomous LEV can obtain subsequent sensor data, such as a second image.

At 670, the method 600 can include determining whether the autonomous LEV has traveled to the particular location based at least in part on the subsequent sensor data. For example, a second image can be used to confirm whether the autonomous vehicle has successfully traveled to the particular location (e.g., a desired destination such as a designated parking spot, charging station, etc.).

If at 670, the autonomous LEV has not traveled to the particular location, at 680, the method 600 can include determining one or more subsequent navigational instructions based at least in part on the subsequent sensor data. For example, uncertainty in the sensor data, margins for error in one or more models used to determine the initial navigational instructions, and/or other circumstances (e.g., weather, unforeseen obstacles, third-party interference, etc.) may have caused the autonomous LEV to not complete its travel to the particular location. The one or more subsequent navigational instructions can be one or more navigational instructions to travel from the then current location of the autonomous LEV to the particular location.

At 690, the method 600 can include causing the autonomous light electric vehicle to initiate travel based at least in part on the one or more subsequent navigational instructions. For example, a vehicle control system can control the autonomous LEV to travel in the direction (e.g., a heading) for the distance indicated in the one or more subsequent navigational instructions. In this way, a computing system can iteratively determine navigational instructions for traveling to a particular location.

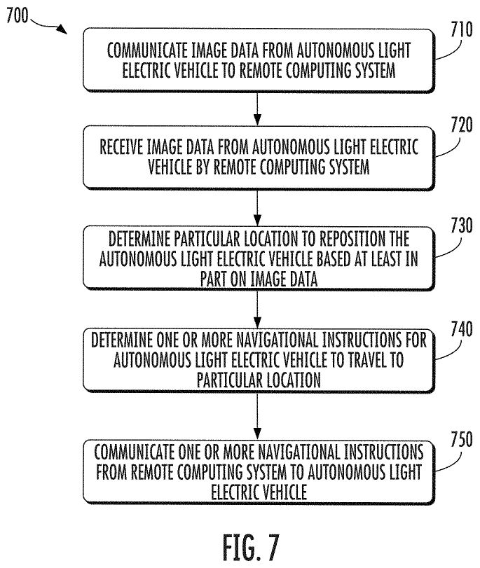

FIG. 7 depicts a flow diagram of an example method 700 for repositioning an autonomous LEV according to example aspects of the present disclosure. One or more portion(s) of the method 700 can be implemented by a computing system that includes one or more computing devices such as, for example, the computing systems described with reference to the other figures (e.g., a LEV computing system 100, a remote computing system 190, etc.). Each respective portion of the method 700 can be performed by any (or any combination) of one or more computing devices. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 7 is described with reference to elements/terms described with respect to other systems and figures for example illustrated purposes and is not meant to be limiting. One or more portions of method 700 can be performed additionally, or alternatively, by other systems.

At 710, the method 700 can include communicating image data from an autonomous LEV to a remote computing system. For example, a camera onboard the autonomous LEV can obtain the image data and a communications device of the autonomous LEV can communicate the image data to the remote computing system.

At 720, the method 700 can include receiving the image data from the autonomous LEV by the remote computing system. In this way, the remote computing system can obtain the image data from the autonomous LEV.

At 730, the method 700 can include determining a particular location to reposition the autonomous LEV based at least in part on the image data. For example, in some implementations, the image data can be analyzed with a machine-learned model to determine the particular location. For example, the machine-learned model can include an image segmentation model which has been trained to detect one or more of a ground plane, a fiducial path, a LEV designated parking location, a LEV charging station, a LEV collection point, a LEV supply positioning location, or other location as described herein. In some implementations, the particular location can be determined using additional data, such as customer request data, battery charge level data, GPS data, map data, and/or other data.

In some implementations, the particular location to reposition the autonomous LEV can be determined based at least in part on input from a teleoperator. For example, the image data can be displayed on a display screen associated with a teleoperator. The teleoperator can then input the particular location, such as by clicking on an area of the image corresponding to the particular location.

At 740, the method 700 can include determining one or more navigational instructions for the autonomous LEV to travel to the particular location. For example, the one or more navigational instructions can include one or more dead-reckoning instructions, vector-based instructions, and/or waypoint-based instructions.

At 750, the method can include communicating the one or more navigational instructions from the remote computing system to the autonomous LEV. For example, the remote computing system can communicate the one or more navigational instructions, such as in a text file, to the autonomous LEV over a communication network.

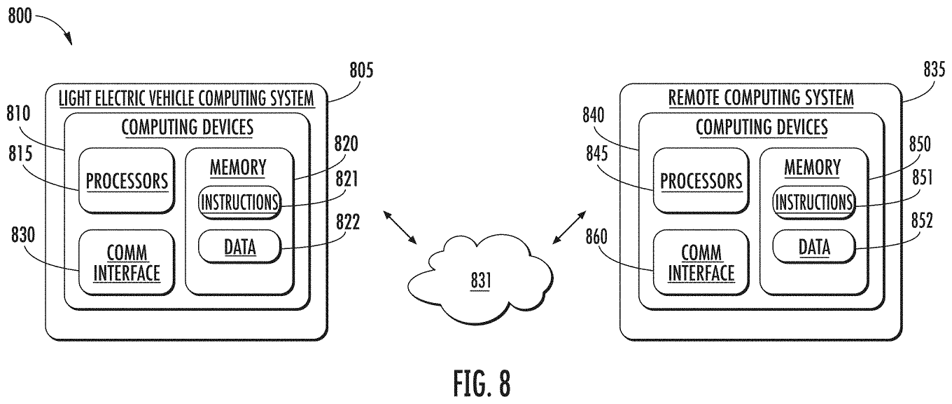

FIG. 8 depicts an example system 800 according to example aspects of the present disclosure. The example system 800 illustrated in FIG. 8 is provided as an example only. The components, systems, connections, and/or other aspects illustrated in FIG. 8 are optional and are provided as examples of what is possible, but not required, to implement the present disclosure. The example system 800 can include a LEV computing system 805 of a vehicle. The LEV computing system 805 can represent/correspond to the LEV computing system 100 described herein. The example system 800 can include a remote computing system 835 (e.g., that is remote from the vehicle computing system). The remote computing system 835 can represent/correspond to a remote computing system 190 described herein. The LEV computing system 805 and the remote computing system 835 can be communicatively coupled to one another over one or more network(s) 831.

The computing device(s) 810 of the LEV computing system 805 can include processor(s) 815 and a memory 820. The one or more processors 815 can be any suitable processing device (e.g., a processor core, a microprocessor, an ASIC, a FPGA, a controller, a microcontroller, etc.) and can be one processor or a plurality of processors that are operatively connected. The memory 820 can include one or more non-transitory computer-readable storage media, such as RAM, ROM, EEPROM, EPROM, one or more memory devices, flash memory devices, data registrar, etc., and combinations thereof.

The memory 820 can store information that can be accessed by the one or more processors 815. For instance, the memory 820 (e.g., one or more non-transitory computer-readable storage mediums, memory devices) on-board the vehicle can include computer-readable instructions 821 that can be executed by the one or more processors 815. The instructions 821 can be software written in any suitable programming language or can be implemented in hardware. Additionally, or alternatively, the instructions 821 can be executed in logically and/or virtually separate threads on processor(s) 815.

For example, the memory 820 can store instructions 821 that when executed by the one or more processors 815 cause the one or more processors 815 (the LEV computing system 805) to perform operations such as any of the operations and functions of the LEV computing system 100 (or for which it is configured), one or more of the operations and functions for determining one or more navigational instructions for an autonomous LEV, one or more portions of methods 600 and 700, and/or one or more of the other operations and functions of the computing systems described herein.

The memory 820 can store data 822 that can be obtained (e.g., acquired, received, retrieved, accessed, created, stored, etc.). The data 822 can include, for instance, sensor data map data, regulatory data, vehicle state data, perception data, prediction data, motion planning data, data associated with a vehicle client, data associated with a service entity's telecommunications network, data associated with an API, data associated with a library, data associated with user interfaces, data associated with user input, data associated with teleoperator input, and/or other data/information such as, for example, that described herein. In some implementations, the computing device(s) 810 can obtain data from one or more memories that are remote from the LEV computing system 805.

The computing device(s) 810 can also include a communication interface 830 used to communicate with one or more other system(s) on-board a vehicle and/or a remote computing device that is remote from the vehicle (e.g., of the system 835). The communication interface 830 can include any circuits, components, software, etc. for communicating via one or more networks (e.g., network(s) 831). The communication interface 830 can include, for example, one or more of a communications controller, receiver, transceiver, transmitter, port, conductors, software and/or hardware for communicating data.

The remote computing system 835 can include one or more computing device(s) 840 that are remote from the LEV computing system 805. The computing device(s) 840 can include one or more processors 845 and a memory 850. The one or more processors 845 can be any suitable processing device (e.g., a processor core, a microprocessor, an ASIC, a FPGA, a controller, a microcontroller, etc.) and can be one processor or a plurality of processors that are operatively connected. The memory 850 can include one or more tangible, non-transitory computer-readable storage media, such as RAM, ROM, EEPROM, EPROM, one or more memory devices, flash memory devices, data registrar, etc., and combinations thereof.

The memory 850 can store information that can be accessed by the one or more processors 845. For instance, the memory 850 (e.g., one or more tangible, non-transitory computer-readable storage media, one or more memory devices, etc.) can include computer-readable instructions 851 that can be executed by the one or more processors 845. The instructions 851 can be software written in any suitable programming language or can be implemented in hardware. Additionally, or alternatively, the instructions 851 can be executed in logically and/or virtually separate threads on processor(s) 845.

For example, the memory 850 can store instructions 851 that when executed by the one or more processors 845 cause the one or more processors 845 to perform operations such as any of the operations and functions of the remote computing system 190 (or for which it is configured), one or more of the operations and functions for determining one or more navigational instructions for an autonomous LEV, one or more portions of methods 600 and 700, and/or one or more of the other operations and functions of the computing systems described herein.

The memory 850 can store data 852 that can be obtained. The data 852 can include, for instance, sensor data map data, regulatory data, vehicle state data, perception data, prediction data, motion planning data, data associated with a vehicle client, data associated with a service entity's telecommunications network, data associated with an API, data associated with a library, data associated with user interfaces, data associated with user input, data associated with teleoperator input, and/or other data/information such as, for example, that described herein.

The computing device(s) 840 can also include a communication interface 860 used to communicate with one or more system(s) onboard a vehicle and/or another computing device that is remote from the system 835, such as LEV computing system 805. The communication interface 860 can include any circuits, components, software, etc. for communicating via one or more networks (e.g., network(s) 831). The communication interface 860 can include, for example, one or more of a communications controller, receiver, transceiver, transmitter, port, conductors, software and/or hardware for communicating data.

The network(s) 831 can be any type of network or combination of networks that allows for communication between devices. In some embodiments, the network(s) 831 can include one or more of a local area network, wide area network, the Internet, secure network, cellular network, mesh network, peer-to-peer communication link and/or some combination thereof and can include any number of wired or wireless links. Communication over the network(s) 831 can be accomplished, for instance, via a communication interface using any type of protocol, protection scheme, encoding, format, packaging, etc.

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for repositioning an autonomous light electric vehicle, comprising:
obtaining, by a computing system comprising one or more computing devices, sensor data from one or more sensors located onboard an autonomous light electric vehicle;
determining, by the computing system, one or more navigational instructions to reposition the autonomous light electric vehicle based at least in part on the sensor data; and
causing, by the computing system, the autonomous light electric vehicle to initiate travel based at least in part on the one or more navigational instructions;
wherein the one or more navigational instructions comprise one or more navigational instructions associated with repositioning the autonomous light electric vehicle at a light electric vehicle designated parking location, a light electric vehicle charging station, a light electric vehicle collection point, a light electric vehicle rider location, or a light electric vehicle supply positioning location.

2. The computer-implemented method of claim 1, further comprising:
determining, by the computing system, an authorized section of a travelway in which the autonomous light electric vehicle is permitted to travel based at least in part on the sensor data; and
wherein the one or more navigational instructions comprises one or more navigational instructions to travel within the authorized section of the travelway.

3. The computer-implemented method of claim 1, further comprising:
determining, by the computing system, that the autonomous light electric vehicle is in a lying down orientation based at least in part on the sensor data; and
in response to determining, by the computing system, that the autonomous light electric vehicle is in the lying down orientation, controlling the autonomous light electric vehicle to an upright orientation.

4. The computer-implemented method of claim 1, wherein the computing system comprises a computing device located onboard the autonomous light electric vehicle; and
wherein determining, by the computing system, the one or more navigational instructions to reposition the autonomous light electric vehicle based at least in part on the sensor data comprises determining, by the computing device located onboard the autonomous light electric vehicle, the one or more navigational instructions to reposition the autonomous light electric vehicle based at least in part on the sensor data.

5. The computer-implemented method of claim 1, wherein the computing system comprises a computing device remote from the autonomous light electric vehicle;
wherein obtaining, by the computing system, the sensor data from the one or more sensors located onboard the autonomous light electric vehicle comprises obtaining, by the remote computing device, the sensor data from the autonomous light electric vehicle;
wherein determining, by the computing system, the one or more navigational instructions to reposition the autonomous light electric vehicle based at least in part on the sensor data comprises determining, by the remote computing device, the one or more navigational instructions to reposition the autonomous light electric vehicle based at least in part on the sensor data; and
wherein the computer-implemented method further comprises communicating, by the remote computing device, the one or more navigational instructions to the autonomous light electric vehicle.

6. The computer-implemented method of claim 1, wherein the computing system comprises a computing device remote from the autonomous light electric vehicle;
wherein obtaining, by the computing system, the sensor data from the one or more sensors located onboard the autonomous light electric vehicle comprises obtaining, by the remote computing device, the sensor data from the autonomous light electric vehicle;
wherein the computer-implemented method further comprises obtaining, by the remote computing device, a teleoperator input;
wherein determining, by the computing system, the one or more navigational instructions to reposition the autonomous light electric vehicle based at least in part on the sensor data comprises determining, by the remote computing device, the one or more navigational instructions to reposition the autonomous light electric vehicle based at least in part on the sensor data and the teleoperator input; and
wherein the computer-implemented method further comprises communicating, by the remote computing device, the one or more navigational instructions to the autonomous light electric vehicle.

7. The computer-implemented method of claim 1, wherein the one or more navigational instructions comprise one or more navigational instructions to travel to a fiducial path and one or more navigational instructions to travel along the fiducial path.

8. The computer-implemented method of claim 7, wherein the one or more navigational instructions further comprise one or more navigational instructions to travel from the fiducial path to a particular location.

9. The computer-implemented method of claim 1, further comprising:
obtaining, by the computing system, subsequent sensor data from the one or more sensors located onboard the autonomous light electric vehicle; and
determining, by the computing system, whether the autonomous light electric vehicle has travelled to a particular location based at least in part on the subsequent sensor data.

10. The computer-implemented method of claim 9, wherein, when the autonomous light electric vehicle has not travelled to the particular location, the method further comprises:
determining, by the computing system, one or more subsequent navigational instructions based at least in part on the subsequent sensor data; and
causing, by the computing system, the autonomous light electric vehicle to initiate travel based at least in part on the one or more subsequent navigational instructions.

11. The computer-implemented method of claim 1, wherein the one or more navigational instructions comprise one or more dead-reckoning instructions, vector-based instructions, or waypoint-based instructions.

12. A computing system, comprising:
one or more processors; and
one or more tangible, non-transitory, computer readable media that store instructions that when executed by the one or more processors cause the computing system to perform operations, the operations comprising:
obtaining image data from one or more cameras located onboard an autonomous light electric vehicle;
determining a particular location to reposition the autonomous light electric vehicle based at least in part on the image data;
determining one or more navigational instructions for the autonomous light electric vehicle to travel to the particular location; and
communicating the one or more navigational instructions to the autonomous light electric vehicle.

13. The computing system of claim 12, wherein determining the particular location to reposition the autonomous light electric vehicle based at least in part on the image data comprises:
displaying the image data on a display screen associated with a teleoperator; and
receiving the particular location as an input from the teleoperator.

14. The computing system of claim 12, wherein determining the particular location to reposition the autonomous light electric vehicle based at least in part on the image data comprises analyzing the image data with a machine-learned model to determine the particular location; and
wherein the machine-learned models comprises an image segmentation model which has been trained to detect one or more of: a ground plane, a fiducial path, a light electric vehicle designated parking location, a light electric vehicle charging station, a light electric vehicle collection point, or a light electric vehicle supply positioning location.

15. The computing system of claim 12, wherein the navigational instructions comprise one or more dead-reckoning instructions, vector-based instructions, or waypoint-based instructions.

16. An autonomous light electric vehicle comprising:
one or more sensors;
one or more processors; and
one or more tangible, non-transitory, computer readable media that store instructions that when executed by the one or more processors cause the one or more processors to perform operations, the operations comprising:
obtaining sensor data from the one or more sensors;
determining one or more navigational instructions to travel to a particular location based at least in part on the sensor data; and
causing the autonomous light electric vehicle to initiate travel based at least in part on the one or more navigational instructions;
wherein the particular location comprises a designated light electric vehicle parking location, a light electric vehicle charging station, a light electric vehicle collection point, a light electric vehicle rider location, or a light electric vehicle supply positioning location.

17. The autonomous light electric vehicle of claim 16, wherein determining the one or more navigational instructions to travel to the particular location based at least in part on the sensor data comprises:
determining one or more navigational instructions to travel to a fiducial path based at least in part on the sensor data; and
wherein at least one of the one or more navigational instructions to travel to the particular location comprise instructions to follow at least a portion of the fiducial path.

18. The autonomous light electric vehicle of claim 17, wherein determining the one or more navigational instructions to travel to the particular location based at least in part on the sensor data further comprises:
determining one or more navigational instructions to travel from the fiducial path to the particular location.

19. The autonomous light electric vehicle of claim 16, wherein the autonomous light electric vehicle comprises a bicycle or a scooter.

20. The autonomous light electric vehicle of claim 16, further comprising:
an orientation adjustment device configured to cause the autonomous light electric vehicle to stand up from a lying down orientation to an upright orientation; and
wherein the operations further comprise:
determining that the autonomous light electric vehicle is in the lying down orientation based at least in part on the sensor data; and
in response to determining that the autonomous light electric vehicle is in the lying down orientation, standing up the autonomous light electric vehicle from the lying down orientation to the upright orientation using the orientation adjustment device.
